(19) United States
(12) Patent Application Publication
(10) Pub. No.: US 2012/0177549 A1
(43) Pub. Date: Jul. 12, 2012

(54) Sample Holder

(75) Inventor: Lars Allers, Oxfordshire (GB)

(73) Assignee: MANTIS DEPOSITION LIMITED, Oxfordshire (GB)

(21) Appl. No.: 13/382,777

(22) PCT Filed: Jul. 13, 2010
(86) PCT No.: PCT/GB2010/001328

§ 371 Date: Mar. 14, 2012

(30) Foreign Application Priority Data
Jul. 14, 2009 (GB) 0912217.7

(51) Int. Cl. B01L 3/00

(52) U.S. Cl. 422/561

(57) ABSTRACT

A sample holder comprises a first thermal mass, a second thermal mass, and a sample vessel, the first and second thermal masses being movable relative to each other thereby to selectively place one or other in thermal contact with the sample vessel, at least one of the thermal masses being held at an elevated temperature. By moving the thermal masses appropriately, the sample holder can be brought into contact with each selectively, adjusting its temperature toward that of the thermal mass with which it is in contact relatively rapidly to allow close and rapid control of the sample temperature. The sample vessel is preferably biased toward the second thermal mass and can be slidably supported on at least one pin extending from the second thermal mass. The first thermal mass and/or the second thermal mass can comprise at least one block of copper. The second thermal mass can comprise, a pair of copper blocks/located either side of the first thermal mass. Generally, we prefer that it is the first thermal mass that is held at an elevated temperature. This allows the sample to default to a cool(er) state.

### FIELD OF THE INVENTION

The present invention relates to a sample holder. It provides a sample holder that is particularly useful in vacuum conditions for certain samples of a difficult nature.

### BACKGROUND ART

There are a wide range of vacuum deposition processes. All do however have one thing in common; a material that is to be deposited is forced into a gaseous state by some means, and is allowed to condense on a substrate of some form.

The evaporation process may be forced by the use of an elevated temperature, or by the use of energetic particles (such as in sputter deposition) or by other means. For some materials, however, there is a conflict in that the elevated temperature needed for evaporation is close to or even in the same range as a temperature at which the material will degrade. An example of such a material that may need to be deposited in vacuum is the dyes for organic LEDs, which are themselves sensitive organic materials. If maintained at an elevated temperature for a sufficient time, they will degrade.

### SUMMARY OF THE INVENTION

The present invention seeks to provide a sample holder, preferred embodiments of which are able to overcome these difficulties. It therefore provides a sample holder comprising a first thermal mass, a second thermal mass, and a sample vessel, the first and second thermal masses being movable relative to each other thereby to selectively place one or other in thermal contact with the sample vessel, at least one of the thermal masses being held at an elevated temperature. By moving the thermal masses appropriately, the sample holder can be brought into contact with each selectively. Assuming that the thermal capacity of the sample holder is significantly less than that of the thermal masses, it will then adjust its temperature toward that of the thermal mass with which it is in contact relatively rapidly, allowing close and rapid control of the sample temperature.

The sample vessel is preferably biased toward the second thermal mass. This allows the movement of the sample holder relative to the thermal masses to be simplified; by default it will return to the second mass. If movement of the first thermal mass relative to the second thermal mass brings it into contact with the sample vessel and (ideally) further movement of the first thermal mass urges the sample vessel away from the second thermal mass, then only the movement of one part (the first thermal mass) needs to be controlled.

To achieve this, the sample vessel can be slidably supported on at least one pin extending from the second thermal mass. The or each pin can carry a coil spring urging the sample vessel toward the second thermal mass, thereby achieving the necessary bias toward the second thermal mass whilst still allowing a degree of movement away from the second thermal mass.

The first thermal mass and/or the second thermal mass can comprise at least one block of copper. Indeed, the second thermal mass can comprise a pair of copper blocks, ideally located either side of the first thermal mass. In this case, the sample vessel is preferably slidably supported on a pair of pins, each extending from one of the two copper blocks forming the second thermal mass.

Generally, we prefer that it is the first thermal mass that is held at an elevated temperature. This allows the sample to default to a cool(er) state.

### BRIEF DESCRIPTION OF THE DRAWINGS

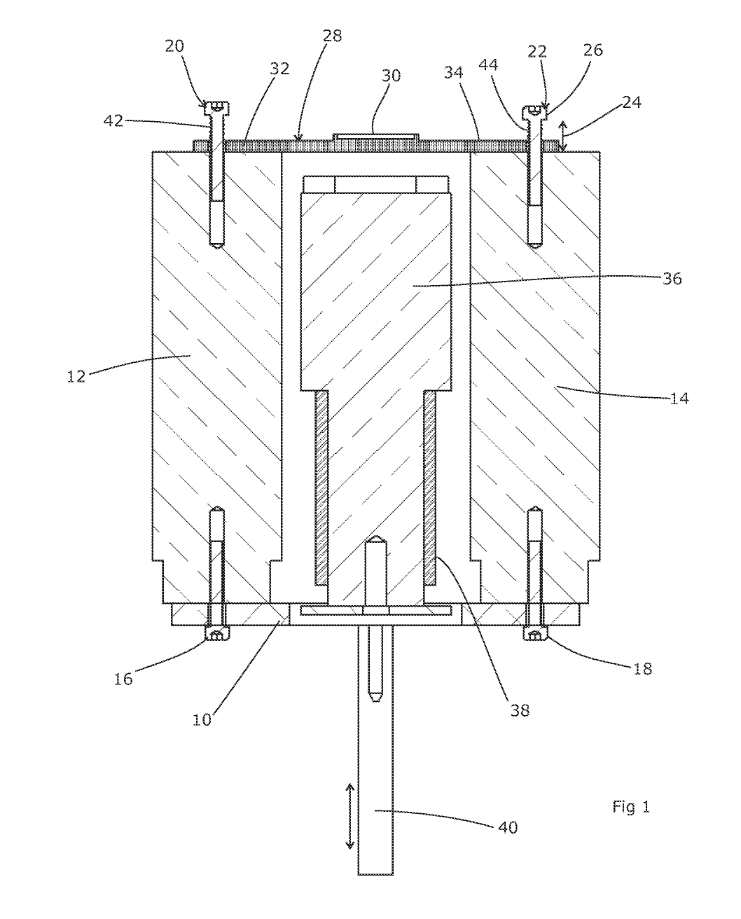

An embodiment of the present invention will now be described by way of example, with reference to the accompanying FIG. 1, which is a vertical section through a sample holder according to the present invention.

### DETAILED DESCRIPTION OF THE EMBODIMENTS

FIG. 1 shows a sample holder according to the present invention. This comprises a substrate 10 which can be mounted to a support in a generally known manner. Extending upwardly from the substrate 10 are a pair of second thermal masses 12, 14 which are in the form of substantial solid cylindrical masses of copper, of substantially identical length. These are secured to the substrate 10 via bolts 16, 18. At their free ends, each carries a respective bolt 20, 22 which extends from the end of the relevant mass 12, 14 thereby defining a section of spindle or pin 24, the bolt head 26 of each bolt 20, 22 defining an oversize end to the spindle or pin. A sample holder 28 is mounted on the ends of the second thermal masses 12, 14, and comprises a raised central region 30 within which a sample may be placed, and laterally extending arms 32, 34. Each arm 32, 34 contains a through-hole through each of which one of the bolts 20, 22 passes. Thus, the sample holder 28 is able to slide along the spindle sections 24, between two extreme positions—one in contact with the thermal masses 12, 14 and one in which the sample holder 28 is physically separated from the thermal masses 12, 14 and restrained from further movement by the bolt heads 26.

A first thermal mass 36 is located centrally in the sample holder, between the second thermal masses 12, 14. This is likewise in the form of a substantial solid cylindrical block of copper, differing in that it is somewhat shorter than the second thermal masses 12, 14 and it is (in part) somewhat thinner so that it can accommodate around its outer extremity a heater sleeve 38 which is adapted to raise the first thermal mass 36 to an elevated temperature compared to that of the second thermal masses 12, 14.

An operating handle 40 is connected to the first thermal mass 36 and extends rearwardly into the sample holder. It can be adjusted longitudinally so as to drive the first thermal mass 36 upwardly relative to the second thermal masses 12, 14. When fully withdrawn, the shorter length of the first thermal mass 36 relative to the second thermal masses 12, 14 means that the first thermal mass 36 sits separately from the sample holder 28. As the first thermal mass 36 is moved, it will eventually come into contact with the rear face of the sample holder 28, and further movement will lift the sample holder 28 out of contact with the second thermal masses 12, 14 and along the spindle sections 24. The bolt heads 26 will provide a limit to such movement, but in practice it is likely to be preferable to limit movement of the first thermal mass 36 so as to stop somewhat short of that point, using the bolt heads 26 only as an emergency stop.

Each of the bolts 20, 22 is provided with a spring 42, 44 around the shaft, acting between the bolt head 26 and the relevant extending arm 32, 34 to urge the sample holder 28 back into contact with the second thermal masses 12, 14. Thus, when movement of the first thermal mass 36 is reversed and the latter is withdrawn into the position shown in FIG. 1, the sample holder 28 will gradually be urged back along the spindle sections 24 until it is once again in contact with the second thermal masses 12, 14.

In this way, by movement of the first thermal mass 36, sample holder 28 can be placed alternatively in contact with a cold thermal mass or a hot thermal mass, thereby allowing careful control of its temperature. This allows the temperature of sensitive sample materials to be kept within an acceptable range, and to be returned to a cool state once the source is no longer needed, thereby alleviating degradation of the sample.

The unit could be operated in a variety of ways, such as by a negative feedback system sensing the instantaneous temperature of the sample holder 28 and thereby controlling movement of the first thermal mass 36. However, in practise the preferable manner of operation is likely to be to retain the second thermal masses 12, 14 in a substantially cold state and to control the heater sleeve 38 of the first thermal mass 36 thermostatically so as to maintain the first thermal mass 36 at the desired “hot” temperature for the sample held within the sample holder 28. In this way, when deposition is required, the first thermal mass 36 can be advanced and the sample will quickly heat up to the desired hot temperature. When deposition can be allowed to cease, the first thermal mass 36 can be withdrawn and the sample will quickly return to a cool state.

It will of course be understood that many variations could be made to the above described embodiment without departing from the scope of the present invention. For example, the thermal masses could be reversed with a hot thermal mass or pair of hot thermal masses on either side of a central cool mass. Equally, the shape and configuration of the thermal masses could be adjusted, with (for example) a cylindrical annular thermal mass extending around a central thermal mass. Other variations will be apparent to the skilled reader.

1. A sample holder comprising a first thermal mass, a second thermal mass, and a sample vessel, the first and second thermal masses being movable relative to each other thereby to selectively place one or other in thermal contact with the sample vessel, at least one of the thermal masses being held at an elevated temperature.

2. A sample holder according to claim 1 in which the sample vessel is biased toward the second thermal mass.

3. A sample holder according to claim 1 in which movement of the first thermal mass relative to the second thermal mass brings it into contact with the sample vessel.

4. A sample holder according to claim 3 in which further movement of the first thermal mass urges the sample vessel away from the second thermal mass.

5. A sample holder according to claim 1 in which the sample vessel is slidably supported on at least one pin extending from the second thermal mass.

6. A sample holder according to claim 5 in which the pin carries a coil spring urging the sample vessel toward the second thermal mass.

7. A sample holder according to claim 1 in which the first thermal mass comprises at least one block of copper.

8. A sample holder according to claim 1 in which the second thermal mass comprises at least one block of copper.

9. A sample holder according to claim 1 in which the second thermal mass comprises a pair of copper blocks.

10. A sample holder according to claim 9 in which the pair of copper blocks forming the second thermal mass are located either side of the first thermal mass.

11. A sample holder according to claim 10 in which the sample vessel is slidably supported on a pair of pins, each extending from one of the two copper blocks forming the second thermal mass.

12. A sample holder according to claim 1 in which the first thermal mass is the thermal mass being held at an elevated temperature.

13. (canceled)
